(19) United States
(12) Patent Application Publication
(10) Pub. No.: US 2010/0252211 A1
(43) Pub. Date: Oct. 7, 2010

(54) SHIM

(75) Inventors: Antony Barnes, Cheshire (GB); Andrew Greening, Cheshire (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: LOUVER-LITE LIMITED, Cheshire (GB)

(21) Appl. No.: 12/753,200

(22) Filed: Apr. 2, 2010

(30) Foreign Application Priority Data
Apr. 3, 2009 (GB) 0905756.3
Apr. 3, 2009 (GB) 0905775.3

(51) Int. Cl. E06B 9/44; E21B 19/16

(52) U.S. Cl. 160/120; 160/323.1; 403/202

(57) ABSTRACT

A shim for reducing play between a roller blind tube and a roller blind end plug, the shim including a rib receiving portion sized and configured to receive a rib from a roller blind tube, wherein the shim is capable of being located between adjacent splines of a roller blind end plug.

### TECHNICAL FIELD

The present invention relates to a shim for reducing play between a roller blind tube and a roller blind end plug. In particular, the shim may be used in conjunction with a blind linkage suitable for linking together two adjacent blinds.

### BACKGROUND

In conventional roller blinds, a roller tube is mounted between a pair of roller blind end plugs. This is typically achieved by providing the end plugs with a number of splines or fins which in use are located within the roller blind tube. In order to rotationally couple the roller blind tube to the end plugs, the roller blind tube typically includes one or more radially inwardly projecting ribs which extend along the entire length of the tube. The rib or ribs are circumferentially spaced such that they sit between a pair of adjacent splines of the two end plugs. However, the ribs tend to smaller than the gap defined between the adjacent splines. This results in the roller tube being able to rotate by a small amount relative to each end plug, which rotational freedom is referred to herein as “play”.

Where a single roller blind is used, this play is acceptable, as the only noticeable effect is that there may be a small delay between operating the control mechanism which raises or lowers the blind and the blind actually moving.

However, where two or more blinds are located adjacent to each other and coupled such that both are operated simultaneously from a single control mechanism, the play between the end plugs and the roller tube may cause problems. For example, where two blinds are mounted adjacent each other, the amount of play is effectively trebled, as there is firstly the play between the control end plug and the roller tube, secondly the play between the roller tube and the idle end of the first blind, and thirdly the play between the drive end plug and the roller tube of the second blind. This combined play between the tubes and the end plugs can translate to a linear mismatch between the blinds in use, which is not desired by the user.

The present invention seeks to address and/ameliorate this problem.

### SUMMARY OF THE INVENTION

According to a first aspect of the invention, there is provided a shim for reducing play between a roller blind tube and a roller blind end plug, the shim including a rib receiving portion sized and configured to receive a rib from a roller blind tube, wherein the shim is capable of being located between adjacent splines of a roller blind end plug.

The shim according to the invention therefore fills the gap between the roller tube ribs(s) and the splines of the end plugs, which reduces or substantially eliminates the rotational play between the two components.

For the avoidance of doubt, the term “shim” is intended to refer to a spacer which is used to fill small gaps or spaces between objects, for example, between a roller tube rib and a pair of end plug splines.

In an embodiment of the invention, the shim is adapted to abut both of the respective inwardly facing surfaces of the two adjacent splines. By having the shim abut both of the inwardly facing surfaces of the adjacent splines, there is little or no rotational play between the shim and the end plug.

When considering a roller blind end plug having a plurality of splines, it may be unusual to refer to “inwardly facing” and “outwardly facing”, as the splines are typically circumferentially spaced about a body which is circular in cross-section such that the splines extend radially outwardly from the body. However, in the context of the present invention, reference is made to two adjacent (i.e. neighbouring) splines. In this case, the “inwardly facing” surfaces are the surface which substantially face towards each other and the “outwardly facing” surfaces are the opposite faces of the splines (i.e. those surfaces which face away from each other).

In a further embodiment of the invention, the rib receiving portion includes a base and a pair of opposed side walls. Suitably, the side walls are spaced and angled to receive therebetween at least a portion of a roller tube rib.

The skilled person will appreciate that the rib of a roller tube typically does not include parallel side walls; the rib tends to be substantially trapezoidal in cross section. As such a rib receiving portion including a base and a pair of opposed walls which are spaced and angled to receive therebetween at least a portion of a roller tube rib provides a snug fit in use for the rib portion therein.

In a still further embodiment of the invention, an outwardly facing surface of one of the side walls abuts an inwardly facing surface of a first spline and an outwardly facing surface of the other side wall abuts an inwardly facing surface of a second spline located adjacent to the first spline. The base typically sits on a body portion of the end plug which carries the spines.

In this embodiment, the base and the walls of the rib receiving portion substantially completely fill the space(s) between the rib, or a portion thereof, and the gap defined between the adjacent splines and the body of the end plug.

A further embodiment of the invention provides a shim which further includes a securing element capable of securing the shim in use to an end plug or a roller blind tube. Suitably, the securing element is adapted to secure the shim to an end plug.

The ability to secure the shim to either an end plug or a roller blind tube makes is easier for an installer to install the roller blind, as the shim is secured to one of the components and the other component can then simply be located in the relevant position.

In a further embodiment, the securing element includes an arm which in use engages an outwardly facing surface of one of the two adjacent splines.

In this embodiment, the shim is secured to an end plug by the arm. The arm and the rib receiving portion define a gap which is sized and configured such that a spline may be secured within the gap, for example via a friction fit of the spline within the gap.

To provide a more secure arrangement, the securing element may include a pair of arms, wherein in use, one of the arms engages an outwardly facing surface of one of the two adjacent splines and the other arm engages an outwardly facing surface of the other of the two adjacent splines.

Thus, each of the two splines is sandwiched between a respective arm and the rib receiving portion. In embodiments where the rib receiving portion includes a pair of opposed side walls, the splines may be sandwiched between a respective arm and wall.

This arrangement prevents the radial removal of the shim from the end plug. The shim is secured to and removed from the end plug in an axial direction.

A second aspect of the invention provides a roller blind including a roller tube comprising at least one rib projecting radially inwardly from the tube, an end plug comprising a pair of adjacent splines projecting outwardly from a body, and a shim as defined anywhere herein located between the adjacent splines.

A third aspect of the invention provides a kit for installing a roller blind, the kit including a roller blind tube including at least one radially inwardly projecting rib, an end plug including a pair of adjacent splines projecting outwardly from a body, and a shim as defined anywhere herein.

A fourth aspect of the invention provides a blind linkage for linking two blinds, the linkage comprising a common bracket, a first end plug adapted to be secured to a first roller blind and a second end plug adapted to be secured to a second roller blind located adjacent to the first roller blind, wherein the first end plug includes a shaft extending axially therefrom, the second end plug defines an axial channel adapted to receive the shaft, and the common bracket defines an aperture configured to receive therethrough the shaft and to act as a bearing for the shaft, whereby in use the second end plug is supported by the shaft and the shaft is supported by the common bracket; and at least one of the first and second end plugs includes a shim as defined anywhere hereinabove.

By having the first and second end plugs supported by a single common bracket, the need for two separate brackets is removed. Furthermore, the sides of the two blind fabrics can be mounted closer together, thereby reducing light strike.

In an embodiment of the invention, there is provided a blind linkage as defined above, wherein the common bracket includes a mounting plate and a support plate extending substantially perpendicularly therefrom, and wherein the support plate defines the aperture.

This type of mounting bracket can be secured to a wall or ceiling via the mounting plate in order to support both the first and second end plugs of the two adjacent blinds.

In a further embodiment of the invention, the shaft is formed from a polymeric material and the common bracket includes a bush made from a polymeric material. It is advantageous to form the shaft from a polymeric material. However, the common bracket is typically formed from metal. The polymeric bush, which surrounds the aperture defined by the bracket, reduces wear on the shaft that may otherwise be caused by the rotation of the polymeric shaft within the metal bracket.

In an embodiment of the invention, the second end plug is free to rotate about the shaft relative to the first end plug.

In certain applications, it is desirable to control the two adjacent blinds separately. In the embodiment described immediately above, the first and second end plugs both form idle ends and the opposite end of each blind includes a control end. By having the two end plugs being able to rotate relative to each other and independently of each other, one of the blinds can be raised or lowered while the other blind is maintained in a stationary position. In other words, the two blinds can be operated independently of each other.

Alternatively, it may be desired to operate both blinds simultaneously, using just one control end to operate both blinds. In such a situation, the shaft of the first end plug may include a first engagement element and the second end plug may include a second engagement element and the first and second engagement elements may be adapted to engage each other to prevent the second end plug rotating relative to the first end plug in use.

In this embodiment, the first blind includes a control end and the second blind is effectively slaved to the first blind such that the second end plug becomes a drive end for the second blind.

In a still further embodiment, the first engagement element includes one or more flats provided on the shaft and the second engagement element includes corresponding flat or flats defined in the channel.

By providing the first end plug with one or more flats provided on the shaft, it may be used with a second end plug in which the channel defined therein is substantially circular in cross section and the aperture has a diameter which is sufficient to allow the shaft to rotate therein. This provides an arrangement in which the first and second end plugs can rotate relative to each other. Alternatively, it can be used with a second end plug in which the channel defined therein includes a corresponding flat or flats which are capable of engaging the flat or flats of the shaft and prevent relative rotation of the first and second end plugs. This provides an arrangement in which the second end plug is slaved to the first end plug.

Accordingly, by providing the shaft with one or more flats, the operation of the two blinds can be determined by the selection of the appropriate second end plug; it can either rotate relative to the first end plug or it can be fixed relative to the first end plug.

A suitable arrangement of flats on the shaft may include a single flat, which results in the shaft having substantially a D-shape in cross section, or a pair of opposed flats, which provide increased engagement surfaces for a second end plug having corresponding flats defined in the channel.

In order further to minimise production costs, the shaft of the first end plug may be a separate element which is releasably secured to the first end plug. Thus, the first end plug may include a body and a separate shaft adapted to be releasably secured to or within the body. In this embodiment, the first end plug body may be identical to a second end plug which includes the second engagement element. Accordingly, to slave the second blind to the first blind, it is possible to use two identical end plugs, one of which having secured thereto the shaft and forms the first end plug and the other of which engaging the shaft in such a way that the two end plugs are rotatably fixed to each other via the shaft.

Accordingly, in a further embodiment, the first end plug includes a body which defines therein an axial channel including a second engagement element and a shaft which includes a first engagement element adapted to engage the second engagement element and prevent rotation of the end plug body relative to the shaft. The shaft may further including a lock element which has a lock configuration in which the shaft is secured to the end plug body and a release position in which the shaft is releasable from the end plug body.

The lock element may allow axial insertion of the shaft into the channel defined by the first end plug body and is adapted to prevent axial removal of the shaft from the channel when fully inserted. In an embodiment of the invention, the channel defined by the first end plug body extends axially throughout the entire length of the body (i.e. the channel is a through-hole) and the lock element includes a stop element which is adapted to prevent axial removal of the shaft from the channel. The stop element may include a pair of opposed resiliently deformable legs formed at one end of the shaft, wherein each leg includes a lug at the distal end thereof. In this embodiment, the shaft may be inserted through the channel by inward deformation of the legs and the legs return to their rest (i.e. non-deflected) position when the lugs exit the other end of the channel. The lugs then engage a stop or outwardly facing surface of the body and prevent the unwanted removal of the shaft from the channel. Such a snap-fit type arrangement will be well known to a skilled person.

The lock element may further include a spring to bias the shaft to project outwardly from the channel to the extent permitted by the lugs. In other words, the stop element prevents axial removal of the shaft from the channel and the spring resists axial displacement of the shaft into the channel.

A fifth aspect of the invention provides a pair of roller blinds which include a blind linkage as defined anywhere hereinabove.

A sixth aspect of the invention provides a kit including a first roller blind, a first end plug adapted to engage one end of the first blind, a second roller blind, a second end plug adapted to engage one end of the second blind and a common bracket, wherein the first end plug includes a shaft extending axially therefrom, the second end plug defines a channel therein adapted to receive the shaft, the common bracket defines an aperture configured to receive therethrough the shaft and to act as a bearing for the shaft, and at least one of the first and second end plugs includes a shim as defined anywhere hereinabove.

In an embodiment of the invention, the shaft includes a first engagement element. This may, for example be formed by one or more flats carried on the outer surface of the shaft.

In a further embodiment of the invention, the channel defined by the second end plug is substantially circular in cross section.

In a still further embodiment of the invention, the channel defined by the second end plug includes a second engagement element which is adapted to engage a first engagement element provided on the shaft of the first end plug.

The first and second engagement elements may be as defined anywhere herein.

Thus, the kit may include a first end plug comprising a shaft which includes a first engagement element, a free second end plug which defines a channel therein which is substantially circular in cross section and configured to permit rotation of the shaft therein, and a slave second end plug, wherein the channel defined therein includes a second engagement element which is adapted to engage the first engagement element to prevent relative rotation of the first and second end plugs; and wherein at least one of the first end plug and the slave second end plug includes a shim as defined anywhere hereinabove.

The shaft, the first end plug and the second end plug may include any optional feature or combination of optional features as defined and described herein

A seventh aspect of the invention provides a kit for linking a pair of adjacent blinds, the kit including one or more drive end plugs, one or more free rotation end plugs and one or more shafts, wherein the or each drive end plug comprises a body which defines therein an axial channel including a second engagement element, the or each free rotation end plug comprises a body which defines therein an axial channel capable of rotation relative to the shaft, and the or each shaft includes a first engagement element which is adapted to engage the second engagement element of the drive end plug channel; and wherein the or each drive end plugs includes a shim as defined anywhere herein.

According to this aspect of the invention, the two roller blinds can be slaved together for simultaneous operation by selection of a drive end plug for each of the adjacent ends of the tubes and linking the two drive end plugs together with one of the shafts, the first engagement element of which engages with the second engagement element of both end plugs to prevent relative rotation of the two adjacent end plugs. Alternatively, the two blinds can be operated independently of each other by selecting either a drive end plug or a free rotation end plug as one of the end plugs and a free rotation end plug as the other end plug and linking the two adjacent end plugs together via one of the shafts, whereby either one or both of the end plugs can rotate relative to the shaft and thus the two end plugs are free to rotate relative to each other.

The skilled person will appreciate that the features described and defined in connection with the aspects of the invention and the embodiments thereof may be combined in any combination, regardless of whether the specific combination is expressly mentioned herein. Thus, combinations of optional features are within the scope of the invention.

An embodiment of the invention will now be described, by way of example only, with reference to the accompanying drawings in which:

### BRIEF DESCRIPTION OF THE DRAWINGS

FIG. 1 is a perspective view of a shim according to the invention secured to an end plug;

FIG. 2 is an exploded perspective view of the shim and end plug shown in FIG. 1;

FIG. 3 is perspective view of a pair of coupled end plugs, each of which includes a respective shim secured thereto;

FIG. 4 is an exploded perspective view of a blind linkage including first and second engagement elements to prevent relative rotation;

FIG. 5 is a perspective view showing an alternative second end plug which is free to rotate relative to the first end plug; and

FIG. 6 is an exploded perspective view of a blind linkage in which the shaft is a separate component.

### DETAILED DESCRIPTION

For the avoidance of doubt, the skilled person will appreciate that in this specification, the terms “up”, “down”, “front”, “rear”, “upper”, “lower”, “width”, “above”, “below”, etc. refer to the orientation of the components of the invention when installed for normal use as shown in the Figures.

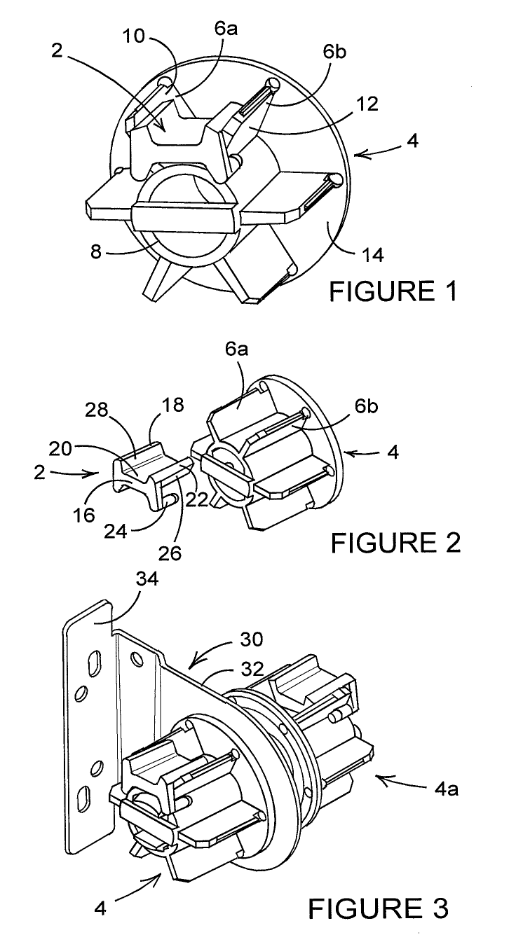

A shim 2 according to the invention is shown in FIG. 1 and FIG. 2. The shim 2 comprises a body 16 and extending from the body a pair of opposed walls 18, 22 and a base 20. The walls 18, 22 are angled such that they flare outwards and diverge from each other and are spaced apart such that the gap defined between the wall 18, 22 is substantially equal to the corresponding width of a rib of a roller blind tube (not shown).

The walls 18, 22 have an inwardly facing surface 28 (only one is shown) and an outwardly facing surface 26 (again, only one is shown).

The inwardly facing surface 28 of the walls 18, 22 and the upwardly facing surface of the base 20 define a channel for receiving therein a portion of a roller blind rib (not shown).

Extending from a portion of the body 16 below the base 20 is a pair of arms 24 (only one of which is shown in the drawings). The arms 24 are substantially cylindrical and extend from the body 16 in the same direction as the base 20 and walls 18, 22. Thus the arms 24 extend substantially perpendicularly from the body 16 and define a gap between each of the arms 24 and the respective wall 18, 22.

In use, the shim 2 is located between a pair of adjacent splines 6a, 6b of an end plug 4 by urging the shim 2 axially towards an endplate 14 of the end plug 4. Each of the splines 6a, 6b forms a friction fit within the gap defined by the respective arm 24 and wall 18, 22 such that the outwardly facing surfaces 26 of the walls 18, 22 abut respective inwardly facing surfaces 10 of the splines 6a, 6b and the downwardly facing surface of the base 20 abuts an outwardly facing surface of an annular body 8 of the end plug 4. The arms 24 are each located at the intersection of the splines 6a, 6b and the annular body 8 such that each of the arms 24 abuts both the outwardly facing surface 12 of the respective spline 6a, 6b and the outwardly facing surface of the annular body 8.

The inwardly facing surface 28 of the walls 18, 22 and the upwardly facing surface of the base 20 of the shim 2 define a channel for receiving therein a portion of a roller blind rib, such that the roller blind rib is a snug fit within the channel. In this way, the shim 2 substantially removes the play between the roller blind rib and the end plug.

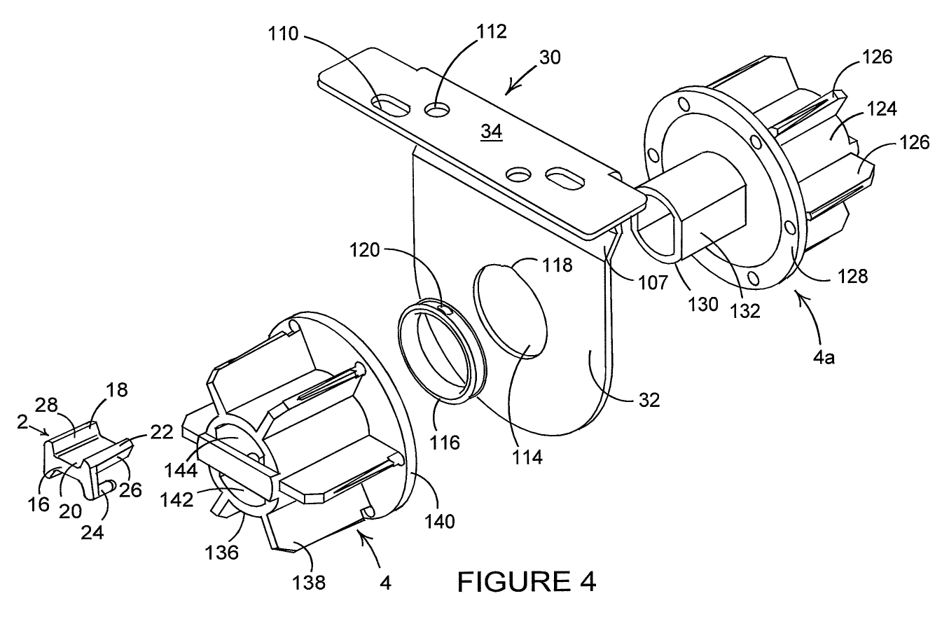

FIG. 3 shows an embodiment where two end plugs 4, 4a are linked together and each end plug 4, 4a includes a respective shim 2. The end plugs 4, 4a are coupled together via a shaft (not shown) and supported by a common support bracket 30, which includes a mounting element 34 and a support element 32. The support element defines an aperture (shown in FIGS. 4 and 6) which acts as a bearing for the shaft. The support bracket 30 is discussed in more detail below.

FIG. 4 shows a blind linkage according to a second embodiment of the invention as an exploded view. The linkage includes the common support bracket 30 which consists of the mounting element 34, including holes 110, 112 formed therein through which screws or other fixings may pass in order to secure the bracket 30 to a suitable surface, such as a wall or ceiling. Depending downwardly (as shown in FIG. 4) from the mounting element 34 is the support element 32. A portion 107 of the support element 32 is angled such that the main section of the support element 32 defines a plane which approximately bisects the mounting element 34 along its longitudinal axis. The support element 32 is formed from a metal such as aluminium or steel.

The support element 32 defines therein an aperture 114 which is substantially circular in cross section. Located around the circumference of the aperture 114 is a bush 116 formed of a polymeric material, such as nylon. The bush 116 includes a lug 120 which is configured to fit within a notch 118 formed in the circumference of the aperture 114. The engagement of the lug 120 within the notch 118 prevents the bush 116 rotating relative to the support element 32.

The common bracket 30 is shown in FIGS. 4 and 6 with the support element 32 projecting perpendicularly from the mounting element 34 in an arrangement which is suitable for securing the common bracket 30 to a ceiling or other suitable downwardly facing horizontal surface in the case of FIG. 4, or a wall or other suitable vertical surface in the case of FIG. 6.

A further element of the blind linkage is a first end plug 4. The first end plug 4 includes a body 136 from which extend radially outwards six splines 138. The splines 138 receive the shim 2 as described above and the channel defined by the inwardly facing surface 28 of the walls 18, 22 and the upwardly facing surface of the base 20 of the shim 2 receives therein a corresponding inwardly projecting rib carried by a roller tube (not shown) such that the first end plug 4 is rotationally fixed relative to the roller tube with little or no play therebetween. At one end of the body 136 is an annular end plate 140 which has a diameter that is slightly greater than the diameter defined by the splines 138.

The final element of the blind linkage 2 according to the second embodiment is a second end plug 4a. The second end plug 4a has a number of features which correspond to the first end plug 4. In particular, it includes a body 124, six splines 126 extending radially therefrom and an annular end plate 128 which are all as described above with respect to the first end plug 4. The second end plug 4a is shown in FIG. 4 without the corresponding shim 2, but the skilled person will appreciate that the shim 2 is fitted to the second end plug 4a in the same way as to the first end plug 4 prior to insertion of the second end plug 4a into a corresponding roller tube (not shown).

Projecting axially from the end plate 128, away from the body 124, is a shaft 130. The shaft 130 is approximately the same length as the body 124. The shaft 130 includes opposed flats 132 which extend axially on opposite sides of the shaft 130 and along its entire length.

Instead of a shaft, the end plate 140 and body 136 of the first end plug 4 define a channel 142 which is configured to receive therein the shaft 130 of the second end plug 4a. The channel 142 includes a pair of opposed flats 144 corresponding to the flats 132 defined by the shaft 130.

The channel 142 and the flats 144 are sized such that the shaft 130 of the second end plug 4a, when inserted therein, is prevented from rotating relative to the first end plug 4 via the interengagement of the two pairs of opposed flats 132, 144.

In use, the mounting bracket 30 is secured to a suitable surface, for example a ceiling, via fixings located through one or more of the holes 110, 112. The polymeric bush 116 is then located within the aperture 114 such that the lug 120 is located within the notch 118.

The first end plug 4 is located within an idle end of a first roller blind tube (not shown) and the second end plug 4a is located within a drive end of a second roller blind tube (also not shown). The shaft 130 of the second end plug 4a is inserted into the aperture 114 of the support element 32 until the end plate 128 is adjacent the corresponding face of the support element 32. The shaft 130 is free to rotate within aperture 114 and the bush 116 acts as a bearing for the shaft 130.

The first end plug 4 is then arranged such that a portion of the shaft 130 of the second end plug 4a is located within the channel 142 defined by the end plate 140 and the body 136. When inserted, the flats 132 of the shaft 130 are disposed adjacent the corresponding flats 144 of the channel.

The end plate 140 is located adjacent the opposite face of the support element 32 when the shaft 130 is inserted in the channel 142 of the first end plug 4. This can be seen in more detail in FIG. 3. With both of the end plates 128, 140 separated by just the thickness of the support element 32, the gap between the adjacent edges of the two roller blind fabrics is minimised.

By virtue of this arrangement, the first end plug 4 and the second end plug 4a are rotationally fixed relative to each other, but both end plugs 4, 4a are free to rotate together within the aperture 114 defined by the support element 32. Furthermore, play between the end plugs 4, 4a and their respective roller tubes is minimised or eliminated by virtue of the shims 2 located therebetween. This enables the skilled person to align the blind fabrics with a significantly reduced risk that they will become mis-aligned in use.

Accordingly, when the first roller tube is rotated by a user, the first end plug 4, which forms the idle end of the first roller blind, rotates by virtue of the engagement of the splines 138 with the ribs (not shown) of the roller tube via the shim 2. The rotation of the first end plug 4 causes the second end plug 4a also to rotate, as the shaft 130 is rotatably fixed within the channel 142 (i.e. the shaft is not able to rotate relative to the channel, so rotation of the shaft result in rotations of the second end plug). The rotation of the second end plug 4a drives the roller tube of the second roller blind (not shown) to rotate correspondingly, again by virtue of the interengagement of the splines 126 with ribs formed in the second roller tube, again via the shim 2.

In this arrangement, the two adjacent roller blinds are operated simultaneously from a single control end, as the second roller blind is slaved to the first roller blind.

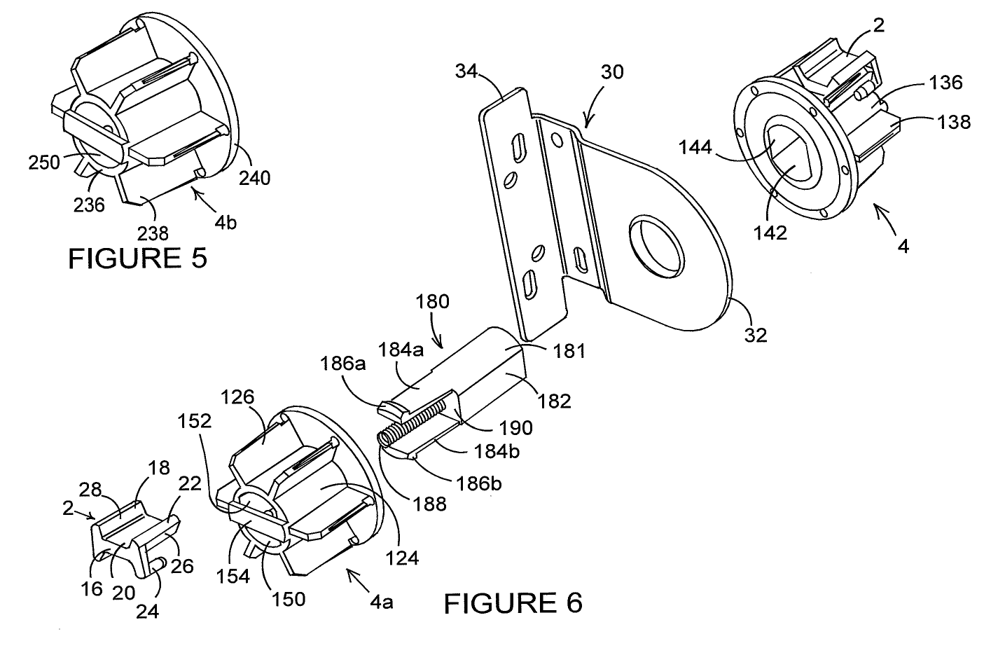

A third embodiment of the invention is provided by an alternative first end plug 4b which is shown in FIG. 5.

In this embodiment, the alternative first end plug 4b is substantially identical to the first end plug 4 of the second embodiment, except for the channel defined therein.

Thus, the alternative first end plug 4b includes a body 236 which has six splines 238 extending radially therefrom. As with the second embodiment, the body 236 terminates at one end in an end plate 240, which is of circular cross section. However, instead of a channel including a pair of opposed flats, the body 236 and the end plate 240 of the alternative first end plug 4b define a channel 250 having a circular cross section.

The diameter of the channel 250 is substantially identical to the diameter of the channel 142 of the second embodiment. However, the absence of the flats in the channel 250 allows the shaft 130 to rotate freely within the channel 250.

The skilled person will appreciate that although not shown in FIG. 5, the alternative first end plug includes a shim 2 secured thereto prior to insertion into an open end of a respective roller blind tube.

In use, the common bracket is secured as described in connection with the second embodiment and the second end plug 4a is located within an idle end of a roller blind tube as described above.

The alternative first end plug 4b is located within an idle end of a second roller blind tube (not shown) and the shaft 130 of the second end plug 4a is inserted into the channel 250 defined within the alternative first end plug 4b. However, in this embodiment, the alternative first end plug 4b is capable of rotating relative to the second end plug 4a.

Accordingly, in the third embodiment, the first and second roller blinds are each provided with their own respective control ends and the alternative first end plug 4b and the second end plug 4a both form respective idle ends of the adjacent roller blinds. This means that each of the roller blinds may be controlled independently of the other one.

A further embodiment of the invention is shown in FIG. 6. The arrangement of the embodiment shown in FIG. 6 is similar to that shown in FIG. 4. However, an alternative shaft arrangement is provided for the second end plug 4a.

The body of the second end plug 4a of this embodiment is identical to the first end plug 4 shown in detail in FIG. 4 and described above. Accordingly, the second end plug comprises a body 124 which defines therein an axial channel 150 which extends the entire length of the body. The channel 150 includes a pair of opposed flats 152 and has at a distal end thereof (i.e. the end furthest from the first end plug 4 in use) a spring retaining bar 154. The second end plug 4a also includes six circumferentially spaced radially extending fins 126.

A shaft 180 is provided which is releasably secured to the second end plug 4a. The shaft 180 includes a body 181 including pair of opposed flats 182 (only one of which is shown in FIG. 6), which correspond to the flats 152 formed in the channel 150 of the second end plug 4a. Extending from one end of the body 181 is a pair of opposed resiliently deformable legs 184a, 184b. Each of the legs 184a, 184b has a radially outwardly extending lug 186a, 186b formed at the distal end thereof. Located between the legs 184a, 184b is a helical compression spring 188, which abuts a stop surface 190 defined by the body 181.

In this embodiment, the common bracket 30 and the first end plug 4 are as defined above with reference to FIG. 4.

In use, the spring 190 is located between the legs 184a, 184b of the shaft 180. The flats 182 of the shaft 180 are aligned with the flats 152 of the channel 150 of the second end plug 4a and the legs 184a, 184b of the shaft 180 are then deflected inwards as the shaft 180 is urged into the channel 150 defined in the second end plug 4a. The free end of the spring 188 contacts the inwardly facing surface of the spring retaining bar 154 and then the lugs 186a, 186b exit the channel 150. Upon exiting the channel 150, the lugs 186a, 186b are no longer constrained by the diameter of the channel 150 and the legs 184a 184b are able to spring back to their rest (i.e. non-deflected) position. The spring 188 biases the shaft 180 out of the channel 150, but axial displacement of the shaft 180 out of the channel is constrained by the lugs 186a, 186b which contact the end plug body 124 and prevent further displacement of the shaft 180 out of the channel 150.

The shaft 180 is then located within the bush 116 of the common bracket 30 and the first end plug 4 is located on the shaft 180 as described above. In this way, the first end plug 4 and the second end plug 4a are rotationally fixed to each other and the second blind is slaved to the first blind.

The skilled person will appreciate that by making the body of the second end plug 4a essentially identical to the first end plug 4, a common component can be used for both end plugs and the only additional component that would be needed is the shaft 180.

The skilled person will further appreciate that the second end plug 4a described above could be used with the alternative first end plug 4b shown in FIG. 5 and described hereinabove to provide a pair of adjacent blinds that can be operated independently of each other.

1. A shim for reducing play between a roller blind tube and a roller blind end plug, the shim including a rib receiving portion sized and configured to receive a rib from a roller blind tube, wherein the shim is capable of being located between adjacent splines of a roller blind end plug.

2. A shim according to claim 1, wherein the rib receiving portion includes a base and a pair of opposed side walls.

3. A shim according to claim 2, wherein the side walls are spaced and angled to receive therebetween at least a portion of a roller tube rib.

4. A shim according to claim 1, further including a securing element adapted to secure the shim in use to an end plug or a roller blind tube.

5. A shim according to claim 4, wherein the securing element includes an arm which in use engages an outwardly facing surface of one of the two adjacent splines.

6. A shim according to claim 5, wherein the securing element includes a pair of arms, wherein in use, one of the arms engages an outwardly facing surface of one of the two adjacent splines and the other arm engages an outwardly facing surface of the other of the two adjacent splines.

7. A roller blind including a roller tube comprising at least one rib projecting radially inwardly from the tube, an end plug comprising a pair of adjacent splines projecting radially outwardly from a body, and a shim according to claim 1 located between the adjacent splines.

8. A blind linkage for linking two blinds, the linkage comprising a common bracket, a first end plug adapted to be secured to a first roller blind and a second end plug adapted to be secured to a second roller blind located adjacent to the first roller blind, wherein the first end plug includes a shaft extending axially therefrom, the second end plug defines an axial channel adapted to receive the shaft, and the common bracket defines an aperture configured to receive therethrough the shaft and to act as a bearing for the shaft, whereby in use the second end plug is supported by the shaft and the shaft is supported by the common bracket; and at least one of the first and second end plugs includes a shim according to claim 1.

9. A blind linkage according to claim 8, wherein the shaft of the first end plug includes a first engagement element and the second end plug includes a second engagement element and the first and second engagement elements are adapted to engage each other to prevent the second end plug rotating relative to the first end plug in use.

10. A blind linkage according to claim 9, wherein the first engagement element includes at least one flat provided on the shaft and the second engagement element includes a corresponding at least one flat defined in the channel.

11. A blind linkage according to claim 8, wherein the shaft is formed from a polymeric material and the common bracket includes a bush made from a polymeric material.

12. A pair of roller blinds including a blind linkage according to claim 8.

13. A pair of roller blinds according to claim 12, wherein a first one of the pair of blinds includes a control end adapted to control the rotation of the first blind and the second blind is slaved to the first blind by the blind linkage such that rotation of the first blind results in a corresponding rotation of the second blind.

14. A kit of parts including a first roller blind, a first end plug adapted to engage one end of the first blind, a second roller blind, a second end plug adapted to engage one end of the second blind and a common bracket, wherein the first end plug includes a shaft extending axially therefrom, the second end plug defines a channel therein adapted to receive the shaft, the common bracket defines an aperture configured to receive therethrough the shaft and to act as a bearing for the shaft, and at least one of the first and second end plugs includes a shim according to claim 1.
